(19) United States
(12) Patent Application Publication
(10) Pub. No.: US 2020/0207677 A1
(43) Pub. Date: Jul. 2, 2020

(54) SYSTEM OF BELOW GROUND COMPOSTING

(71) Applicant: Andrew HAYIM DE VRIES, Byron Bay, New South Wales (AU)

(72) Inventor: Andrew HAYIM DE VRIES, Byron Bay, New South Wales (AU)

(21) Appl. No.: 16/634,153

(22) PCT Filed: Jul. 27, 2018
(86) PCT No.: PCT/AU2018/050785

§ 371 Date: Jan. 26, 2020

(30) Foreign Application Priority Data
Jul. 27, 2017 (AU) 2017902953

(51) Int. Cl. C05F 17/907; C05F 9/02

(52) U.S. Cl. CPC C05F 17/907; C05F 9/02

(57) ABSTRACT

A composting bin adapted to embedding at least partially below a ground surface; the bin forming an enclosure including side portions and a base portion; the side portions and the base portions provided with holes to allow ingress and egress of worms while excluding vermin; the holes further allowing nutrients exuded by composting material placed in the bin to leach into surrounding soil.

The present invention relates to a system of below ground composting including apparatus and a method therefor.

### BACKGROUND

Composting systems are well known in the art. Typically, these systems comprise of a composting bin that sits above ground where the composting process is completed and then the resulting compost is distributed from that bin to its desired usage location. This method, while popular, requires many handling steps including but not limited to moving the bin to encourage the composting process and then manually distributing the resulting compost to its desired usage location.

A recent trend is for users to place the composting bin in the ground in the actual location where the resulting compost is needed and to allow the nutrients from the composting bin to leak from the bin into the surrounding soil. This allows the resulting compost to be accessible to the soil in which the user wishes to target the use of the compost.

Typically, such a system would involve something like a metal barrel where the bottom of the barrel is cut off and the waste material is added from the top of the barrel and the nutrients and compost leach from the bottom of the barrel. The problem with this design is that it does not incorporate needed air flow that is an important part of the composting process. The design also allows rodents and pests to access the compost, typically by digging down and coming up into the barrel or other bin. This is highly undesirable.

The described invention is designed to address these issues or at least provide a useful alternative.

### NOTES

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### SUMMARY OF INVENTION

Accordingly in one broad form of the invention there is provided a composting bin adapted to embedding at least partially below a ground surface; the bin forming an enclosure including side portions and a base portion; the side portions and the base portions provided with holes to allow ingress and egress of worms while excluding vermin; the holes further allowing nutrients exuded by composting material placed in the bin to leach into surrounding soil.

Preferably the holes are sized to suit diameters of worms typical of the surrounding soil in which the bin is located; the holes sufficiently small to prevent ingress of vermin such as rats.

Preferably the bin is further provided with an upper aeration section; the upper aeration section projecting in use above the ground surface.

Preferably the upper aeration section is provided with apertures; the apertures provided with a mesh adapted to prevent ingress of rats or other vermin.

Preferably the bin is provided with a lid; the lid substantially coextensive with the upper aeration section.

Preferably the lid is provided with a lockable mechanism.

Preferably side portions of the bin are stepped; the side portions decreasing in size from a maximum for the upper portion to a minimum for the lowermost portion; the arrangement allowing for collapsing of lower portions of the bin into the upper portion for storage and transport.

Preferably the side portions of the bin are substantially planar; the side portions provided with indented or projecting strengthening sections.

Preferably ends of each bin are provided with male and female interlocking structures; a first end of a bin provided with a male interlocking structure and an opposite second end with a female interlocking structure.

Preferably the male and female interlocking structures allow a number of bins to be interconnected to provide a continuous composting and nutrient producing barrier below a ground surface.

Preferably the bin is provided with sensors monitoring composting performance.

Preferably the sensors include a temperature sensor.

Preferably the sensors include a moisture level sensor.

Preferably the sensors include a soil acidity sensor.

In yet a further broad form of the invention there is provided a method of promoting composting including leaching of nutrients into surrounding soil; the method including the steps of:
providing a composting bin comprising side portions and a base portion; the side portions and base portions provided with plurality of holes,
placing the composting bin substantially embedded below a ground surface; an upper aeration portion of the bin projecting above the ground surface, and
wherein the holes are sized to allow ingress and egress of worms into and out of the bin but prevent ingress of rats and other vermin.

Preferably the holes allow nutrients exuding from compostable material in the bin to leach into soil surrounding the bin.

Preferably each composting bin is provided with interlocking structures at each end of the bin; the interlocking structures allowing a line of bins to form a composting and nutrient producing barrier.

Preferably the composting bin is provided with sensors to monitor composting performance; the sensors including temperature, moisture level and soil acidity sensors.

In yet a further broad form of the invention there is provided a composting bin adapted to partial burial in soil; the bin comprising of side portions, a base portion and an upper aeration portion; the upper aeration portion projecting above a ground surface in use; the side portions and the base portion provided with holes for ingress and egress of worms and for leaching into surrounding soil nutrients produced from compostable material placed in the bin.

### DRAWINGS

Embodiments of the present invention will now be described with reference to the accompanying drawings wherein:

FIG. 1A is a cross section of a first preferred embodiment of a composting bin according to the invention

FIG. 1B is a cross section of a second preferred embodiment of a composting bin according to the invention

FIG. 1C is a cross section of a third preferred embodiment of a composting bin according to the invention

FIG. 2 illustrates a worm access hole diameter of the preferred embodiments

FIG. 3 comprises side views of a fourth preferred embodiment of the invention

### DESCRIPTION AND OPERATION

### First Preferred Embodiment

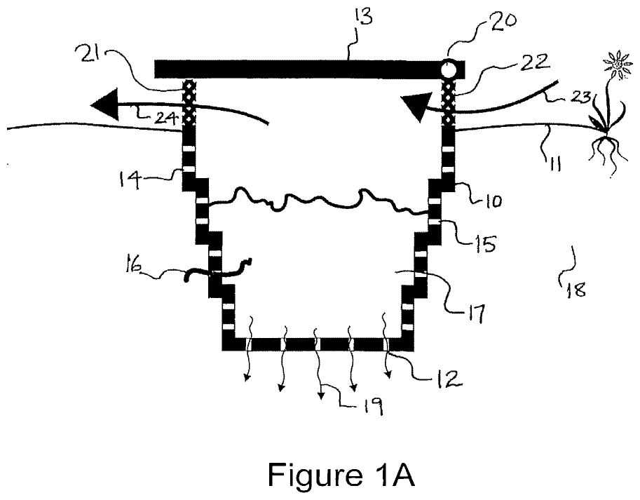

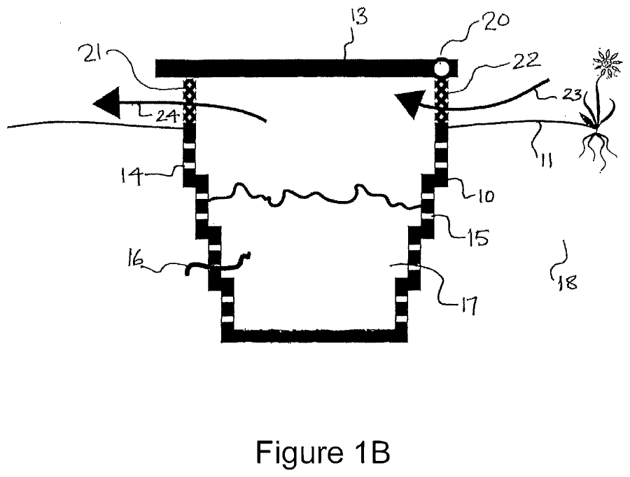

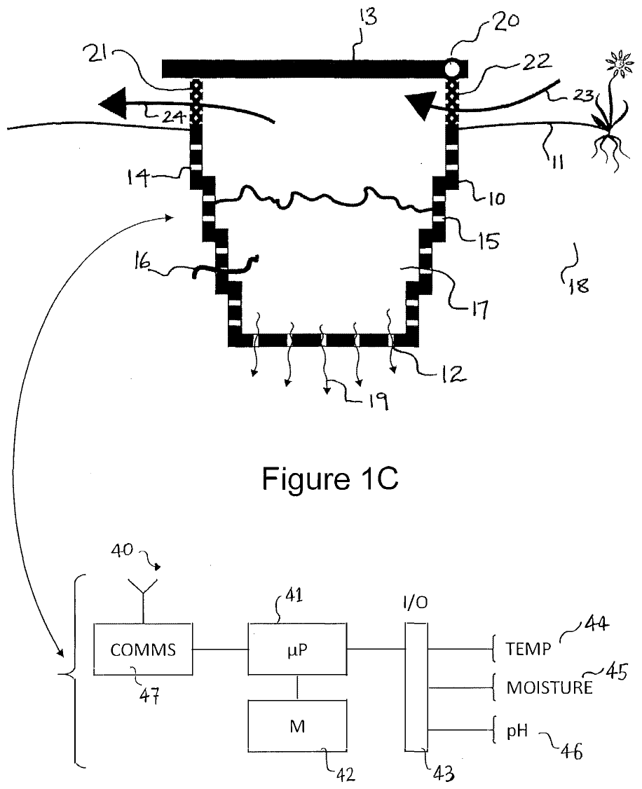

FIG. 1A discloses a cross section of a first embodiment of the invention comprising a composting bin 10 that has a main body that sits substantially under the level of the surface of the ground 11. This first preferred embodiment shows a stepped wall design that makes the composting bin 10 easy to store during transport and storage and is known in the art. The side walls of the bin and its floor or base portion 12 and lid 13 are made of a rodent resistant material provided with holes 14 15 throughout which allow worms 16 and other organisms to pass between the compost 17 and the surrounding dirt 18.

As the compost 17 decomposes the resulting fluid 19 passes through the holes in the bin to improve the condition of the surrounding soil 18.

The example embodiment shows a lid 13 pivoting about a hinge 20 that allows a user to add materials to the composting mix 17.

The lid 13 sits on top of an aeration structure 21 22. In this example embodiment the aeration structure is a metal mesh 21 22 that allows air 23 to pass through 23 24 the compost bin. This allows the compost process area to naturally regulate its temperature. The mesh 21 22 is designed to allow air to circulate without allowing rodents to enter the compost bin.

The result is a compost bin that does not require the collection and redistribution of compost nutrients but rather can automatically distribute the nutrients in situ while being resistant to rodent infestation. The aeration capability of the design also allows the invention to automatically regulate the temperature of the composting process by allowing heat to escape, which is also desirable.

### Second Preferred Embodiment

With reference to FIG. 1B there is illustrated a second embodiment wherein, in this instance, the composting bin 10 does not have holes 14 within the floor or base portion 12.

### Third Preferred Embodiment

With reference to FIG. 1C there is illustrated a third embodiment of the composting bin 10 which, in this instance, is fitted with a monitor unit 40 which in this instance comprises a processor 41 in communication with a memory 42. The processor 41 is further in communication with an input output unit 43 by which signals from sensors such as temperature sensor 44, moisture sensor 45, acidity sensor 46 may be transmitted to the processor 41 for further processing. In some instances the processor 41 may communicate the signals or information otherwise derived from the sensors to a communications module 47 for on-communication—for example to a remote database or like facility.

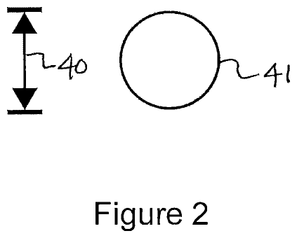

FIG. 2 discloses the ideal diameter size of the worm access holes. The diameter 40 should be greater than the diameter of the desired worms to be used in the composting process and small enough to not allow rodents or other undesirable animals from gaining access to the interior of the compost bin. In the example embodiment the hole 41 is round.

### Fourth Preferred Embodiment

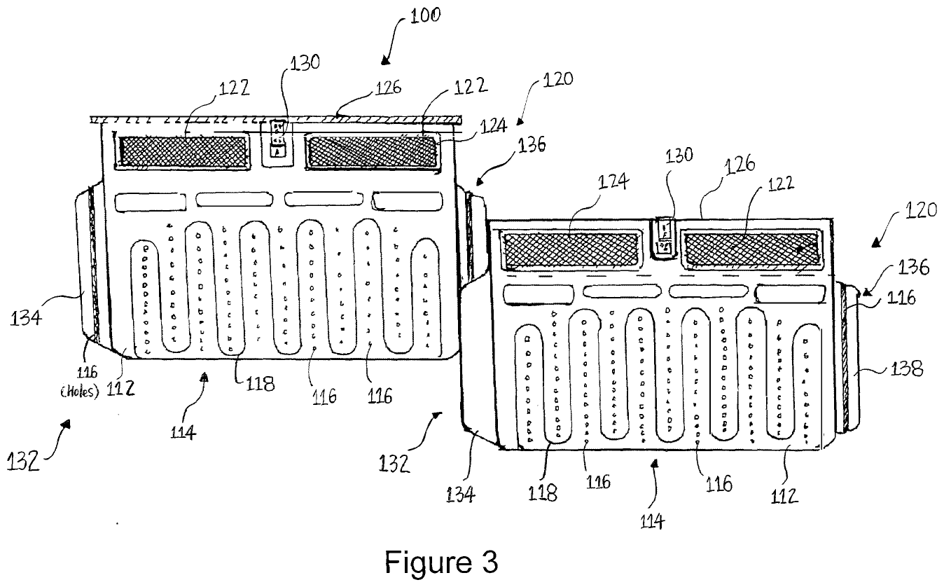

With reference now to FIG. 3, in a further embodiment of the invention, a compost bin 100 is formed of side portions 112 and a base portion 114. As in the first preferred embodiment described above, both the side portions 112 and the base portion 114 are provided with holes 116 which again allow the ingress and egress of worms while excluding vermin, as well as allowing nutrients exuding from composting material in the bin to leach into the surrounding soil. Preferably, the holes are sized to suit the diameters of worms typical to the surrounding soil.

In this embodiment, the side walls 112 of the composting bin 100 are substantially planar but are preferably provided with indentations 118 or projections to strengthen the walls against pressure from the surrounding soil when the composting bin is substantially embedded in soil for use. As for the first preferred embodiment above, the composting bin is provided with an upper aeration section 120 which, in use, projects above a ground surface. The upper aeration section 120 includes apertures 122 which are provided with mesh 124 to allow a free flow of air while preventing ingress of rats or other vermin. A hinged lid 126, substantially coextensive with the upper aeration section 120, provides access for adding or removing composting material. Preferably the lid 126 is provided with a lockable mechanism 130.

A further feature of this second preferred embodiment of the composting bin 100 is the provision at the ends of the bin with interlocking male and female structures. Thus, at a first end 132 of each bin is an integral male interlocking structure 134 while at a second opposite end 136 the bin is provided with a female interlocking structure 138. These interlocking structures allow a number of bins 100 to be interconnected to provide a continuous composting and nutrient providing barrier below a ground surface.

To monitor the performance of the composting bin of either of the above described embodiments, composting bins of the invention may be provided with monitoring sensors, such as temperature, moisture and acidity (pH) levels. In some arrangements these may provide read out data of current or recorded measurements via some communication system such as Bluetooth or over a mobile phone network for remote monitoring.

### Alternative Embodiments

The preferred embodiments preferably use a steel mesh for aeration. An alternative embodiment could use any aeration material that allows air to pass through the top area but stops rodents from entering the compost area inside the bin.

The preferred embodiments use round holes in the walls and floor of the bin. An alternative arrangement could use any shape of hole.

The preferred embodiments have the bin compost area situated below the ground level with the aeration mesh sitting above the ground level. An alternative embodiment could see the bin used at any height relative to the ground level however it is noted that the configuration in the above described embodiments is the preferred configuration.

The preferred embodiments use a recycled hardened plastic for the bin body. Alternative arrangements could use any material that is rodent resistant and will not deteriorate or break down due to the composting process.

### INDUSTRIAL APPLICABILITY

Embodiments of the invention are applicable in the horticulture industries for the purpose of improving composting performance.

1. A composting bin adapted to embedding at least partially below a ground surface; the bin forming an enclosure including side portions and a base portion; the side portions and the base portions provided with holes to allow ingress and egress of worms while excluding vermin; the holes further allowing nutrients exuded by composting material placed in the bin to leach into surrounding soil.

2. The composting bin of claim 1 wherein the holes are sized to suit diameters of worms typical of the surrounding soil in which the bin is located; the holes sufficiently small to prevent ingress of vermin such as rats.

3. The composting bin of claim 1 wherein the bin is further provided with an upper aeration section; the upper aeration section projecting in use above the ground surface.

4. The compositing bin of claim 3 wherein the upper aeration section is provided with apertures; the apertures provided with a mesh adapted to prevent ingress of rats or other vermin.

5. The composting bin of claim 3 wherein the bin is provided with a lid; the lid substantially coextensive with the upper aeration section.

6. The composting bin of claim 5 wherein the lid is provided with a lockable mechanism.

7. The composting bin claim 1 wherein side portions of the bin are stepped; the side portions decreasing in size from a maximum for the upper portion to a minimum for the lowermost portion; the arrangement allowing for collapsing of lower portions of the bin into the upper portion for storage and transport.

8. The composting bin of claim 1 wherein the side portions of the bin are substantially planar; the side portions provided with indented or projecting strengthening sections.

9. The composting bin of claim 1 wherein ends of each bin are provided with male and female interlocking structures; a first end of a bin provided with a male interlocking structure and an opposite second end with a female interlocking structure.

10. The composting bin of claim 9 wherein the male and female interlocking structures allow a number of bins to be interconnected to provide a continuous composting and nutrient producing barrier below a ground surface.

11. The composting bin of claim 1 wherein the bin is provided with sensors monitoring composting performance.

12. The composting bin of claim 11 wherein the sensors include a temperature sensor.

13. The composting bin of claim 11 wherein the sensors include a moisture level sensor.

14. The composting bin of claim 11 wherein the sensors include a soil acidity sensor.

15. A method of promoting composting including leaching of nutrients into surrounding soil; the method including the steps of:
providing a composting bin comprising side portions and a base portion; the side portions and base portions provided with plurality of holes,
placing the composting bin substantially embedded below a ground surface; an upper aeration portion of the bin projecting above the ground surface, and
wherein the holes are sized to allow ingress and egress of worms into and out of the bin but prevent ingress of rats and other vermin.

16. The method of claim 15 wherein the holes allow nutrients exuding from compostable material in the bin to leach into soil surrounding the bin.

17. The method of claim 15 wherein each composting bin is provided with interlocking structures at each end of the bin; the interlocking structures allowing a line of bins to form a composting and nutrient producing barrier.

18. The method of any one of claim 15 wherein the composting bin is provided with sensors to monitor composting performance; the sensors including temperature, moisture level and soil acidity sensors.

19. A composting bin adapted to partial burial in soil; the bin comprising of side portions, a base portion and an upper aeration portion; the upper aeration portion projecting above a ground surface in use; the side portions and the base portion provided with holes for ingress and egress of worms and for leaching into surrounding soil nutrients produced from compostable material placed in the bin.
